(19) United States
(12) Patent Application Publication
(10) Pub. No.: US 2021/0303541 A1
(43) Pub. Date: Sep. 30, 2021

(54) DATA ASSOCIATION SYSTEM AND UPDATE FREQUENCY CHANGE SYSTEM

(71) Applicant: KYOCERA Document Solutions Inc., Osaka-shi (JP)

(72) Inventor: Koki NAKAJIMA, Osaka-shi (JP)

(21) Appl. No.: 17/205,278

(22) Filed: Mar. 18, 2021

(30) Foreign Application Priority Data
Mar. 25, 2020 (JP) 2020-055179

(51) Int. Cl. G06F 16/23

(52) U.S. Cl. CPC G06F 16/23

(57) ABSTRACT

In a data association system including: a data collection system which collects data maintained in an information system; a data storage system which stores the data collected by the data collection system; and a pipeline orchestrator which changes the frequency of update of the data stored by the data storage system, the data association system is characterized in that the pipeline orchestrator causes the data collection system and the data storage system which use a normal update path that updates the data at a specific frequency to temporarily use a high-speed update path that updates the data more frequently than does the normal update path.

### INCORPORATION BY REFERENCE

This application is based upon, and claims the benefit of priority from, corresponding Japanese Patent Application No. 2020-055179 filed in the Japan Patent Office on Mar. 25, 2020, the entire contents of which are incorporated herein by reference.

### BACKGROUND

### Field of the Invention

The present disclosure relates to a data association system which collects and stores data that is maintained in an information system, and to an update frequency change system.

### Description of Related Art

Typically, a data association system which collects and stores data that is maintained in an information system is known.

### SUMMARY

A data association system of the present disclosure includes: a data collection system which collects data maintained in an information system; a data storage system which stores the data collected by the data collection system; and an update frequency change system which changes a frequency of update of the data stored by the data storage system, and the update frequency change system is characterized by causing the data collection system and the data storage system which use a normal update path that updates the data at a specific frequency to temporarily use a high-speed update path that updates the data more frequently than does the normal update path.

An update frequency change system of the present disclosure pertains to an update frequency change system which changes a frequency of update of data, which is stored by a data storage system that stores data, which is collected by a data collection system that collects data maintained in an information system, and is characterized by causing the data collection system and the data storage system which use a normal update path that updates the data at a specific frequency to temporarily use a high-speed update path that updates the data more frequently than does the normal update path.

### BRIEF DESCRIPTION OF THE DRAWINGS

FIG. 1 is a block diagram of a system according to one embodiment of the present disclosure;

FIG. 2 is a block diagram of a pipeline provided in a data storage system shown in FIG. 1;

FIG. 3 is a diagram representing an example of a table of data which is managed by a big-data analysis unit shown in FIG. 1;

FIG. 4 is a sequence diagram of an operation of the system shown in FIG. 1 to be performed when the data managed by the big-data analysis unit is to be updated by a normal update path;

FIG. 5 is a sequence diagram of an operation of the system shown in FIG. 1 to be performed in a case where a high-speed update of data, which is managed by the big-data analysis unit, is instructed by a user;

FIG. 6 is a sequence diagram of an operation of the system shown in FIG. 1 to be performed when the data managed by the big-data analysis unit is to be updated by a high-speed update path; and

FIG. 7 is a sequence diagram of an operation of the system shown in FIG. 1 to be performed when the high-speed update of data managed by the big-data analysis unit is to be terminated.

### DETAILED DESCRIPTION

In the following, embodiments of the present disclosure will be described with reference to the accompanying drawings.

First, a configuration of a system according to one embodiment of the present disclosure will be described.

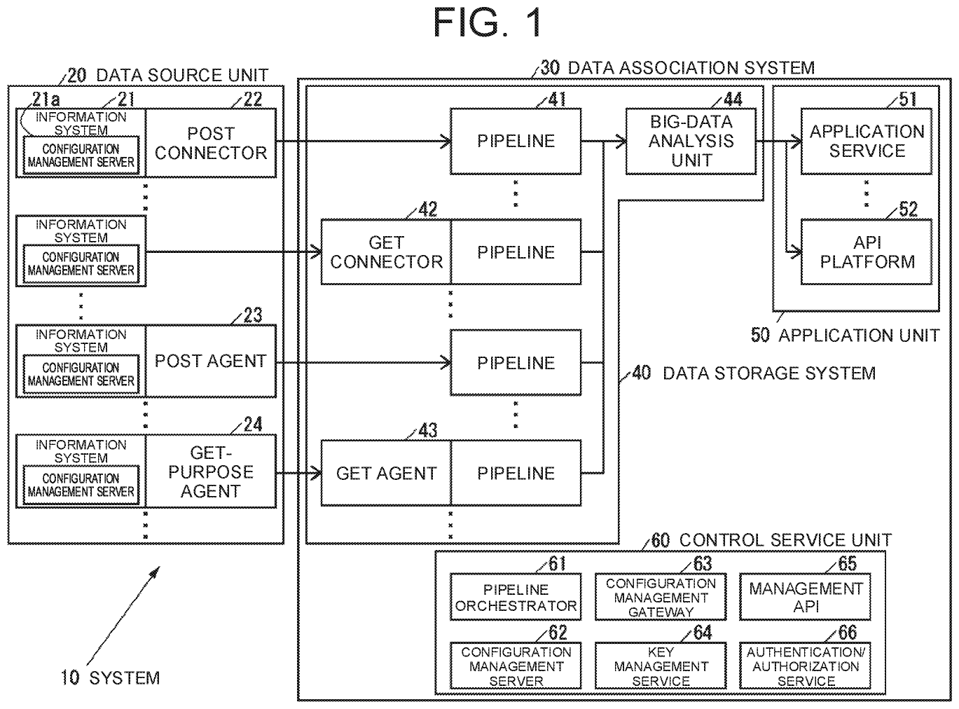

FIG. 1 is a block diagram of a system 10 according to the present embodiment.

As illustrated in FIG. 1, the system 10 includes a data source unit 20 which produces data, and a data association system 30 which associates the data produced by the data source unit 20.

The data source unit 20 includes an information system 21 which produces data. The information system 21 includes a configuration management server 21a which saves the configuration and the settings of the information system 21. The data source unit 20 may also include, in addition to the information system 21, at least one information system. Examples of the information system include an Internet-of-Things (IoT) system such as a remote management system, which remotely manages an image forming apparatus such as a multifunction peripheral (MFP) or a print-only machine, and an in-house system such as an enterprise resource planning (ERP) system or a production management system. Each of the information systems may be configured by a single computer, or may be configured by multiple computers. The information system may have a file of structured data maintained therein. The information system may have a file of unstructured data maintained therein. The information system may have a database of structured data maintained therein.

The data source unit 20 includes a POST connector 22, which serves as a data collection system, for acquiring a file of structured data or unstructured data that is maintained in the information system, and transmitting the acquired file to a pipeline, which will be described later, of the data association system 30. The data source unit 20 may also include, besides the POST connector 22, at least one POST connector having the configuration similar to that of the POST connector 22. The POST connector may be configured by a computer in which the POST connector itself constitutes the information system from which the file is acquired. Note that the POST connector is also a component of the data association system 30.

The POST connector can use either a normal update path which acquires the file of structured data or unstructured data from the information system, and sends the acquired file to the pipeline at a specific frequency, such as once a day, or a high-speed update path which acquires the file of structured data or unstructured data from the information system, and sends the acquired file to the pipeline more frequently than does the normal update path, such as on a real-time basis. Since the high-speed update path uses a database on a memory to execute the processing, the processing speed is faster than that of the normal update path which uses a database on storage to execute the processing. However, the cost of using the high-speed update path is higher than that of the normal update path. Therefore, the POST connector uses the normal update path by default.

The data source unit 20 includes a POST agent 23, which serves as a data collection system, for acquiring structured data from a database of the structured data that is maintained in the information system, and transmitting the acquired structured data to a pipeline, which will be described later, of the data association system 30. The data source unit 20 may also include, besides the POST agent 23, at least one POST agent having the configuration similar to that of the POST agent 23. The POST agent may be configured by a computer in which the POST agent itself constitutes the information system from which the structured data is acquired. Note that the POST agent is also a component of the data association system 30.

The POST agent can use either a normal update path which acquires the structured data from the information system, and sends the acquired structured data to the pipeline at a specific frequency, such as once a day, or a high-speed update path which acquires the structured data from the information system, and sends the acquired structured data to the pipeline more frequently than does the normal update path, such as on a real-time basis. Since the high-speed update path uses a database on a memory to execute the processing, the processing speed is faster than that of the normal update path which uses a database on storage to execute the processing. However, the cost of using the high-speed update path is higher than that of the normal update path. Therefore, the POST agent uses the normal update path by default.

The data source unit 20 includes a GET-purpose agent 24, which serves as a data collection system, for generating structured data for association on the basis of the data maintained in the information system. The data source unit 20 may also include, besides the GET-purpose agent 24, at least one GET-purpose agent having the configuration similar to that of the GET-purpose agent 24. The GET-purpose agent may be configured by a computer which constitutes the information system maintaining the data from which the structured data for association is generated. Note that the GET-purpose agent is also a component of the data association system 30.

The GET-purpose agent can use either a normal update path which generates the structured data for association at a specific frequency, such as once a day, on the basis of the data maintained in the information system, or a high-speed update path which generates the structured data for association more frequently than does the normal update path, such as on a real-time basis, on the basis of the data maintained in the information system. Since the high-speed update path uses a database on a memory to execute the processing, the processing speed is faster than that of the normal update path which uses a database on storage to execute the processing. However, the cost of using the high-speed update path is higher than that of the normal update path. Therefore, the GET-purpose agent uses the normal update path by default.

The data association system 30 includes a data storage system 40 which stores data produced by the data source unit 20, an application unit 50 which uses the data stored in the data storage system 40, and a control service unit 60 which executes various kinds of control over the data storage system 40 and the application unit 50.

The data storage system 40 includes a pipeline 41 which stores the data produced by the data source unit 20. The data storage system 40 may also include, in addition to the pipeline 41, at least one pipeline. Since the configurations of data in the information systems may differ for each information system, the data storage system 40 basically includes a pipeline for each information system. Each of the pipelines may be configured by a single computer, or may be configured by multiple computers.

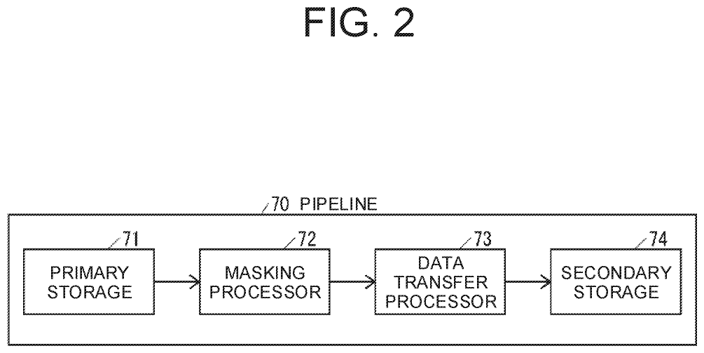

FIG. 2 is a block diagram of a pipeline 70 provided in the data storage system 40.

As illustrated in FIG. 2, the pipeline 70 includes: a primary storage 71 having a storage area for storing the data received from the POST connector, the POST agent, a GET connector to be described later, or a GET agent to be described later; a masking processor 72, which serves as a data conversion system, for executing masking processing as data conversion processing on data relating to privacy, such as personal information of the user of the information system, in the data stored in the primary storage 71; a data transfer processor 73, which executes data transfer processing of transferring the data on which the masking processing is executed by the masking processor 72 to a big-data analysis unit 44 (FIG. 1), which will be described later; and a secondary storage 74 having a storage area for storing data for transfer, which is to be transferred to the big-data analysis unit 44. The reason why the primary storage 71 is provided is that in the processing of the data, if the processing has failed in steps subsequent to the step of storing the data in the primary storage 71, such as in the step of the masking processing and the step of the data transfer processing, the failed processing can be re-executed in a way described below. That is, with the primary storage 71, it is possible to re-execute the failed processing by using the data stored in the primary storage 71, and without needing to retransmit the data from the data source unit 20 to the data association system 30, by which means a network communication cost is high. The primary storage 71 and the secondary storage 74 are not merely storage devices, but are systems capable of executing various kinds of processing as will be described later.

The pipeline 70 can use either a normal update path which processes data of update that is stored in the primary storage 71 by the masking processor 72 and the data transfer processor 73 at a specific frequency, such as once a day, and then stores the processed data in the secondary storage 74, or a high-speed update path which processes the data of update that is stored in the primary storage 71 by the masking processor 72 and the data transfer processor 73 more frequently than does the normal update path, such as on a real-time basis, and then stores the processed data in the secondary storage 74. Since the high-speed update path uses a database on a memory to execute the processing, the processing speed is faster than that of the normal update path which uses a database on storage to execute the processing. However, the cost of using the high-speed update path is higher than that of the normal update path. Therefore, the pipeline 70 uses the normal update path by default.

As illustrated in FIG. 1, the data storage system 40 includes a GET connector 42, which serves as a data collection system, for acquiring a file of structured data or unstructured data that is maintained in the information system, and associating the acquired file with the pipeline. The data storage system 40 may also include, besides the GET connector 42, at least one GET connector having the configuration similar to that of the GET connector 42. The GET connector may be configured by a computer in which the GET connector itself constitutes the pipeline with which the file is associated.

The GET connector can use either a normal update path which acquires a file of structured data or unstructured data from the information system, and associates the acquired file with the pipeline at a specific frequency, such as once a day, or a high-speed update path which acquires the file of structured data or unstructured data from the information system, and associates the acquired file with the pipeline more frequently than does the normal update path, such as on a real-time basis. Since the high-speed update path uses a database on a memory to execute the processing, the processing speed is faster than that of the normal update path which uses a database on storage to execute the processing. However, the cost of using the high-speed update path is higher than that of the normal update path. Therefore, the GET connector uses the normal update path by default.

Note that in the system 10, the data source unit 20 is provided with the POST connector to be adapted to the information system which does not allow a file of structured data or unstructured data to be acquired from the data storage system 40. Meanwhile, in the system 10, the data storage system 40 is provided with the GET connector to be adapted to the information system which allows a file of structured data or unstructured data to be acquired from the data storage system 40.

The data storage system 40 includes a GET agent 43, which serves as a data collection system, for acquiring the structured data generated by the GET-purpose agent, and associating the acquired structured data with the pipeline. The data storage system 40 may also include, besides the GET agent 43, at least one GET agent having the configuration similar to that of the GET agent 43. The GET agent may be configured by a computer in which the GET agent itself constitutes the pipeline with which the structured data is associated.

The GET agent can use either a normal update path which acquires the structured data from the GET-purpose agent, and associates the acquired structured data with the pipeline at a specific frequency, such as once a day, or a high-speed update path which acquires the structured data from the GET-purpose agent, and associates the acquired structured data with the pipeline more frequently than does the normal update path, such as on a real-time basis. Since the high-speed update path uses a database on a memory to execute the processing, the processing speed is faster than that of the normal update path which uses a database on storage to execute the processing. However, the cost of using the high-speed update path is higher than that of the normal update path. Therefore, the GET agent uses the normal update path by default.

Note that in the system 10, the data source unit 20 is provided with the POST agent to be adapted to the information system which does not allow structured data to be acquired from the data storage system 40. Meanwhile, in the system 10, the data source unit 20 is provided with the GET-purpose agent, and the data storage system 40 is provided with the GET agent to be adapted to the information system which allows structured data to be acquired from the data storage system 40.

The data storage system 40 includes the big-data analysis unit 44, which serves as a data conversion system, for executing final conversion processing as data conversion processing of converting the data stored by a plurality of pipelines into a form that can be counted or searched by a query language, i.e., a database language such as SQL, for example. The big-data analysis unit 44 can also execute a search or counting in response to a search request or counting request from the application unit 50 for the data on which the final conversion processing is executed. The big-data analysis unit 44 may be configured by a single computer, or may be configured by multiple computers.

The final conversion processing may include data integration processing of integrating data of a plurality of information systems as the data conversion processing. In a case where the system 10 includes, as the information systems, a remote management system disposed in Asia for remotely managing a large number of image forming apparatuses disposed in Asia, a remote management system disposed in Europe for remotely managing a large number of image forming apparatuses disposed in Europe, and a remote management system disposed in the U.S. for remotely managing a large number of image forming apparatuses disposed in the U.S., each of these three remote management systems has a device management table for management of the image forming apparatuses that the remote management system itself manages. The device management table corresponds to information indicating various kinds of information of the image forming apparatus in association with an ID assigned to each of the image forming apparatuses. Here, since each of the three remote management systems has the device management table of its own individually, it is possible that the same ID will be assigned to different image forming apparatuses among the device management tables of the three remote management systems. Therefore, when the big-data analysis unit 44 integrates the device management tables of the three remote management systems to generate a single device management table, the big-data analysis unit 44 reassigns the IDs of the image forming apparatuses so as to avoid duplication of the IDs.

The big-data analysis unit 44 can use either a normal update path which updates the data managed by the big-data analysis unit 44 itself at a specific frequency, such as once a day, or a high-speed update path which updates the data managed by the big-data analysis unit 44 itself more frequently than does the normal update path, such as on a real-time basis. Since the high-speed update path uses a database on a memory to execute the processing, the processing speed is faster than that of the normal update path which uses a database on storage to execute the processing. However, the cost of using the high-speed update path is higher than that of the normal update path. Therefore, the big-data analysis unit 44 uses the normal update path by default.

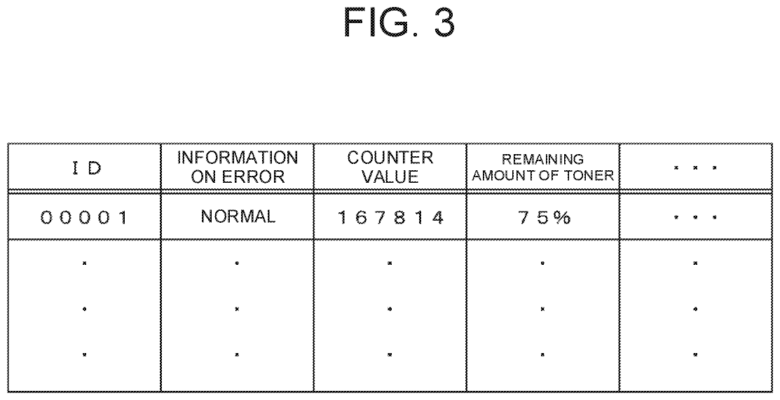

FIG. 3 is a diagram representing an example of a table of data which is managed by the big-data analysis unit 44.

The table shown in FIG. 3 is an image forming apparatus information table showing various kinds of information of the image forming apparatus for each image forming apparatus. For example, the image forming apparatus information table shown in FIG. 3 includes the ID of the image forming apparatus, information on an error in the image forming apparatus, and information indicating the use state of the image forming apparatus such as a counter value indicating a print count of the image forming apparatus, and the remaining amount of toner in the image forming apparatus.

As illustrated in FIG. 1, the application unit 50 includes an application service 51 which uses the data managed by the big-data analysis unit 44 to execute a specific operation instructed by the user, such as display of data and analysis of data. The application unit 50 may also include, in addition to the application service 51, at least one application service. Each of the application services may be configured by a single computer, or may be configured by multiple computers.

The application unit 50 includes an API platform 52 which provides an Application Programming Interface (API) that uses the data managed by the big-data analysis unit 44 and executes a specific operation. The API platform 52 may be configured by a single computer, or may be configured by multiple computers. For example, the APIs to be provided by the API platform 52 include an API which sends, to a consumable ordering system, which is a system outside the system 10, for ordering consumables when the remaining amount of a consumable such as a toner of the image forming apparatus is less than or equal to a specific amount, data on the remaining amount of the consumables collected from the image forming apparatus by means of the remote management system, and an API which sends, to a trouble prediction system, which is a system outside the system 10, for predicting a trouble of the image forming apparatus, various kinds of data collected from the image forming apparatus by means of the remote management system.

The control service unit 60 includes a pipeline orchestrator 61, which serves as a processing monitoring system, for monitoring the processing at each stage to be carried out for the data in the data source unit 20, the data storage system 40, and the application unit 50. The pipeline orchestrator 61 may be configured by a single computer, or may be configured by multiple computers. The pipeline orchestrator 61 can change the frequency of update of data stored by the data storage system 40, and constitutes an update frequency change system of the present disclosure.

The control service unit 60 includes a configuration management server 62 which saves the configuration and the settings of the data storage system 40, and automatically executes deployment as needed. The configuration management server 62 may be configured by a single computer, or may be configured by multiple computers. The configuration management server 62 constitutes a configuration change system which changes the configuration of the data association system 30.

The control service unit 60 includes a configuration management gateway 63 which connects to the configuration management server of the information system, and collects information for detecting a change in the configuration related to the database or unstructured data in the information system, in other words, a change in the configuration of data in the information system. The configuration management gateway 63 may be configured by a single computer, or may be configured by multiple computers.

The control service unit 60 includes a key management service 64 which encrypts and stores security information, such as key information and connect strings, necessary for achieving association between the respective systems such as the information systems. The key management service 64 may be configured by a single computer, or may be configured by multiple computers.

The control service unit 60 includes a management API 65 which accepts requests from the data storage system 40 and the application unit 50. The management API 65 may be configured by a single computer, or may be configured by multiple computers.

The control service unit 60 includes an authentication/authorization service 66 which executes authentication/authorization of the application service of the application unit 50. The authentication/authorization service 66 may be configured by a single computer, or may be configured by multiple computers. The authentication/authorization service 66 can confirm, for example, whether the application service is permitted to request the data of the information system that is stored in the data storage system 40 to be updated to the latest data.

Next, the operation of the system 10 will be described.

First, the operation of the system 10 to be performed when the data managed by the big-data analysis unit 44 is to be updated by a normal update path will be described.

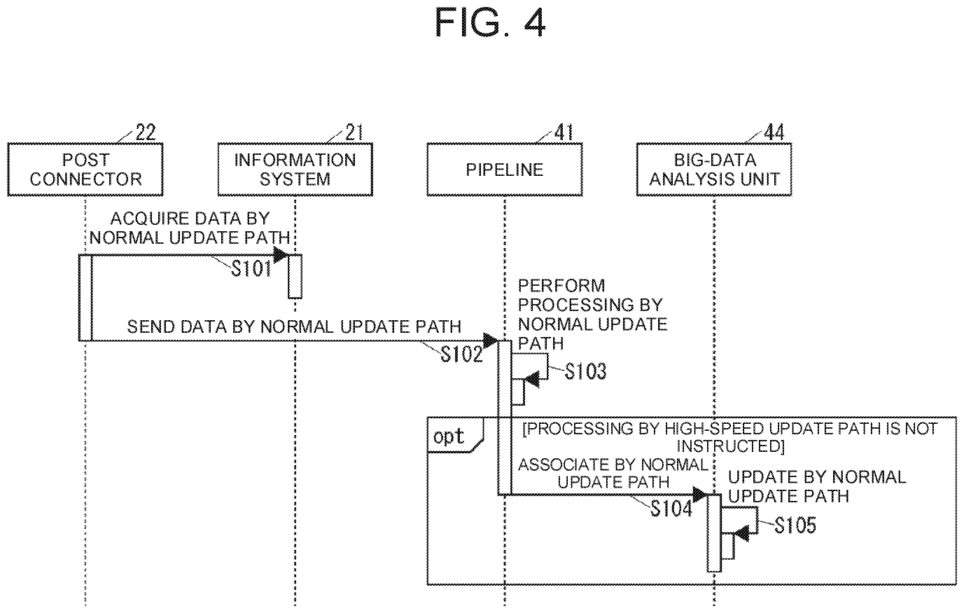

FIG. 4 is a sequence diagram of the operation of the system 10 to be performed when the data managed by the big-data analysis unit 44 is to be updated by the normal update path.

In the following, the POST connector 22 will be described as an example of the connector or the agent. However, the same applies to the POST connector other than the POST connector 22, and the same applies to the POST agent or the GET connector, and also to a combination of the GET-purpose agent and the GET agent.

The POST connector 22 monitors updates of data with respect to the information system 21. In a case where the POST connector 22 has detected an update of data as a result of monitoring conducted with respect to the information system 21, when it is the timing of acquisition of the normal update path, the POST connector 22 acquires, as shown in FIG. 4, the data from the information system 21 by the normal update path (S101), and sends the acquired data to the pipeline by the normal update path (S102).

In the following, the case where the pipeline to which the data has been sent in S102 is the pipeline 41 will be described.

When the data is sent to the pipeline 41 in S102, the pipeline 41 processes the sent data by the normal update path (S103).

Next, the pipeline 41 causes the data for which processing by the high-speed update path is not instructed, in the data obtained after the processing of S103, to be associated with the big-data analysis unit 44 by the normal update path (S104). Note that even if processing by the high-speed update path is instructed, the pipeline 41 stores data which has been stored by the normal update path separately from the data stored by the high-speed update path.

In the big-data analysis unit 44, when the data is associated from the pipeline 41 in S104, the big-data analysis unit 44 updates this data by the normal update path in the data being managed by the big-data analysis unit 44 itself (S105).

Next, the operation of the system 10 to be performed in a case where the user has instructed a high-speed update of the data managed by the big-data analysis unit 44 will be described.

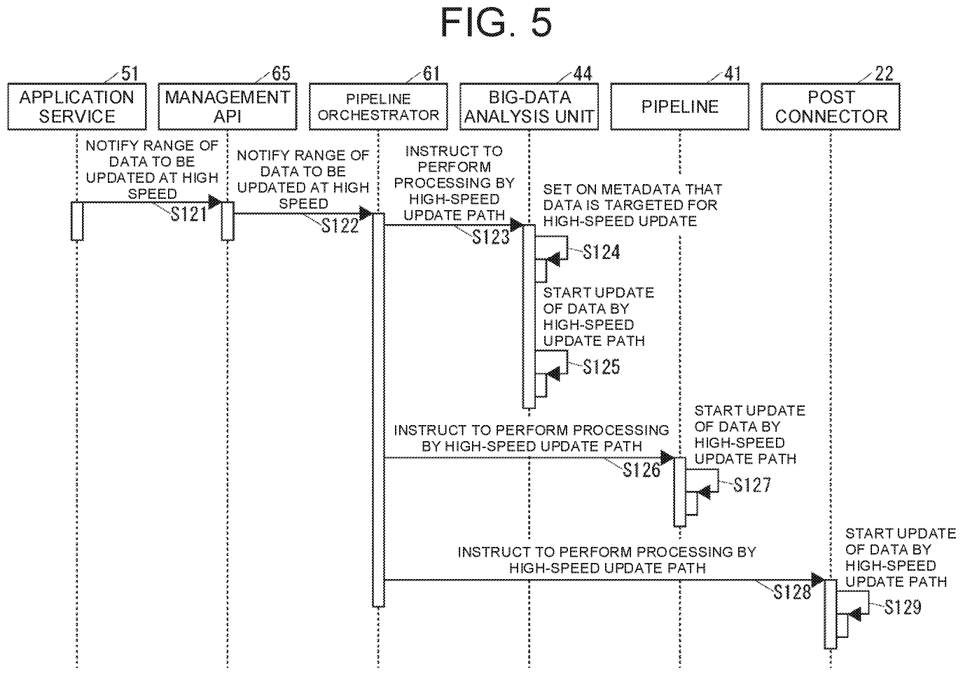

FIG. 5 is a sequence diagram of the operation of the system 10 to be performed in a case where a high-speed update of the data, which is managed by the big-data analysis unit 44, is instructed by the user.

The user can specify the range of data that the user wishes to update at high speed, in the data managed by the big-data analysis unit 44, to the application service. In the above, the range of data that can be specified may be a range indicated by the position of a column or a row of a specific table, i.e., the data of the image forming apparatus information table at the second column from the head, for example. Further, the range of data that can be specified may be a range indicated by the attribute name in a specific table, i.e., the data on the remaining amount of toner in the image forming apparatus information table, for example. Furthermore, the range of data that can be specified may be a range indicated by an arbitrary unique key in a specific table, i.e., the data associated with “00001”, which is the ID of the image forming apparatus, in the image forming apparatus information table, for example.

When the range of data to be updated at high speed in the data managed by the big-data analysis unit 44 is specified by the user, the application service 51 notifies the management API 65 of the specified range (S121), as shown in FIG. 5. Here, if a start time of high-speed update of data is specified by the user, the application service 51 also notifies the management API 65 of the start time. Also, if a termination time of high-speed update of data is specified by the user, the application service 51 also notifies the management API 65 of the termination time. In addition, if a frequency of high-speed update of data is specified by the user, the application service 51 also notifies the management API 65 of the frequency.

When the management API 65 receives the notification of S121, the management API 65 notifies the pipeline orchestrator 61 of the range of data to be updated at high speed, which is notified in S121 (S122). Here, when the management API 65 is notified of the start time of high-speed update of data in S121, the pipeline orchestrator 61 is also notified of the start time. Also, when the management API 65 is notified of the termination time of high-speed update of data in S121, the pipeline orchestrator 61 is also notified of the termination time. In addition, when the management API 65 is notified of the frequency of high-speed update of data in S121, the pipeline orchestrator 61 is also notified of the frequency.

When the pipeline orchestrator 61 receives the notification of S122, the pipeline orchestrator 61 instructs the big-data analysis unit 44 to process the update of data of the range notified in S122 by the high-speed update path (S123). Note that when the pipeline orchestrator 61 is notified of the start time of high-speed update of data in S122, the pipeline orchestrator 61 executes the processing of S123 when the time comes to the start time notified in S122.

When the big-data analysis unit 44 receives the instruction of S123, the big-data analysis unit 44 makes the setting on metadata corresponding to the range specified in S123, in the data being managed by the big-data analysis unit 44 itself, that the data of this range is targeted for high-speed update (S124).

Next, the big-data analysis unit 44 starts the update of data of the range instructed in S123 by the high-speed update path (S125).

After the pipeline orchestrator 61 has performed the processing of S123, the pipeline orchestrator 61 gives an instruction, to have the update of data of the range notified in S122 processed by the high-speed update path, to the pipeline which stores the aforementioned data (S126). FIG. 5 illustrates an example in which the pipeline, which is a target of giving the instruction of S126, is the pipeline 41.

When the pipeline 41 receives the instruction of S126, the pipeline 41 starts the update of data of the range instructed in S126 by the high-speed update path (S127). Note that the pipeline 41 also continues the update by the normal update path for all of the data, which the pipeline 41 itself stores, including the data of the range instructed in S126.

After the pipeline orchestrator 61 has performed the processing of S123, the pipeline orchestrator 61 gives an instruction, to have the update of data of the range notified in S122 processed by the high-speed update path, to the connector or the agent which acquires the aforementioned data from the information system (S128). The connector or the agent, which is a target of giving the instruction of S128, may be, for example, the POST connector, the POST agent, the GET connector, or a combination of the GET-purpose agent and the GET agent. FIG. 5 illustrates an example in which the connector or the agent, which is the target of giving the instruction of S128, is the POST connector 22. In the following, the POST connector 22 will be described as an example of the connector or the agent. However, the same applies to the POST connector other than the POST connector 22, and the same applies to the POST agent or the GET connector, and also to a combination of the GET-purpose agent and the GET agent. Here, when the pipeline orchestrator 61 is notified of the frequency of high-speed update of data in S122, the pipeline orchestrator 61 gives an instruction, in S128, that the update of data of the range notified in S122 should be processed by the high-speed update path, and at the frequency notified in S122, to the connector or the agent which acquires the aforementioned data from the information system.

When the POST connector 22 receives the instruction of S128, the POST connector 22 starts the update of data of the range instructed in S128 by the high-speed update path (S129). Here, when the POST connector 22 is instructed of the frequency in S128, the POST connector 22 starts the update of data of the range instructed in S128 by the high-speed update path, and at the frequency notified in S128. Note that the POST connector 22 also continues the update by the normal update path for all of the data, which the POST connector 22 acquires from the information system 21, including the data of the range instructed in S128.

The above describes the operation of the case where the user has specified the range of data that the user wishes to update at high speed, in the data managed by the big-data analysis unit 44, to the application service 51. However, the same applies to the operation of a case where the user has specified the range of data that the user wishes to update at high speed, in the data managed by the big-data analysis unit 44, to an application service other than the application service 51. Also, the same applies to the operation of a case where the user has specified the range of data that the user wishes to update at high speed, in the data managed by the big-data analysis unit 44, to the API platform 52, except that the API platform 52 performs the operation instead of the application service 51.

Next, the operation of the system 10 to be performed when the data managed by the big-data analysis unit 44 is to be updated by the high-speed update path will be described.

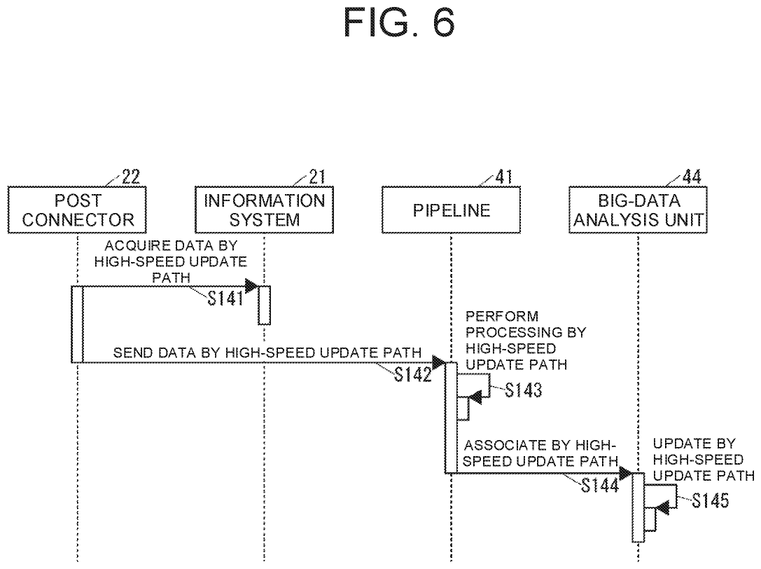

FIG. 6 is a sequence diagram of the operation of the system 10 to be performed when the data managed by the big-data analysis unit 44 is to be updated by the high-speed update path.

In the following, the POST connector 22 will be described as an example of the connector or the agent. However, the same applies to the POST connector other than the POST connector 22, and the same applies to the POST agent or the GET connector, and also to a combination of the GET-purpose agent and the GET agent.

The POST connector 22 monitors updates of data with respect to the information system 21. In a case where the POST connector 22 has detected an update of data of the range instructed in S126 as a result of monitoring conducted for the information system 21, when it is the timing of acquisition of the high-speed update path, the POST connector 22 acquires, as shown in FIG. 6, the data of the range instructed in S126 from the information system 21 by the high-speed update path (S141), and sends the acquired data to the pipeline by the high-speed update path (S142).

In the following, the case where the pipeline to which the data has been sent in S142 is the pipeline 41 will be described.

When the data is transmitted to the pipeline in S142, the pipeline 41 processes the data by the high-speed update path (S143), and causes the data obtained after the processing of S143 to be associated with the big-data analysis unit 44 by the high-speed update path (S144).

In the big-data analysis unit 44, when the data is associated from the pipeline 41 in S144, the big-data analysis unit 44 updates this data by the high-speed update path in the data being managed by the big-data analysis unit 44 itself (S145).

Next, the operation of the system 10 to be performed when the high-speed update of data managed by the big-data analysis unit 44 is to be terminated will be described.

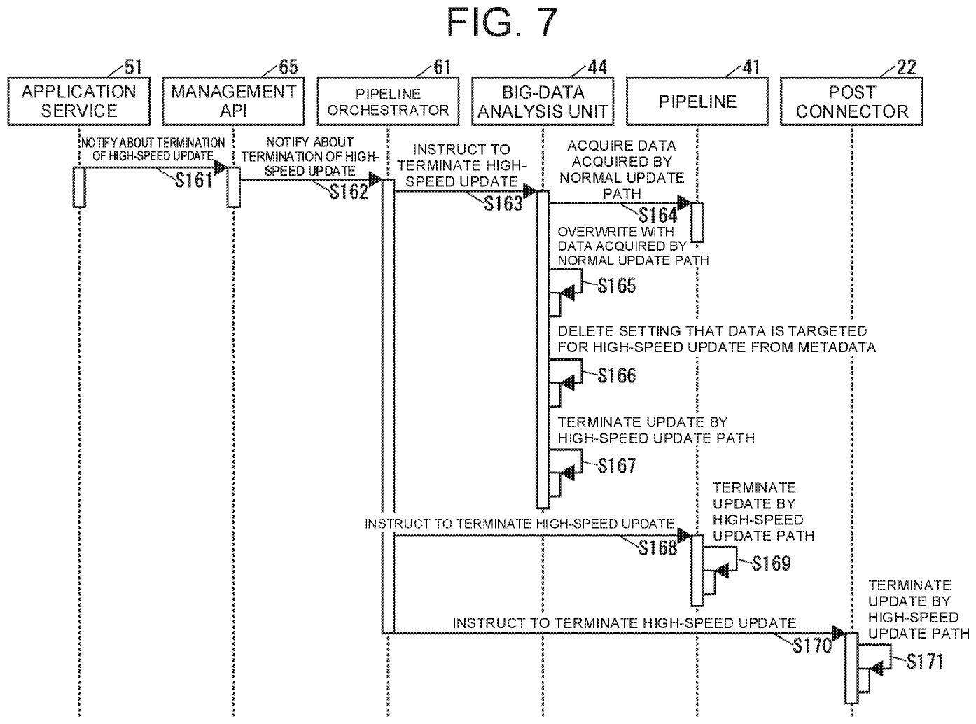

FIG. 7 is a sequence diagram of the operation of the system 10 to be performed when the high-speed update of data managed by the big-data analysis unit 44 is to be terminated.

The user can give an instruction to the application service 51 for termination of the high-speed update of data managed by the big-data analysis unit 44.

When the termination of the high-speed update of data is specified from the user, the application service 51 notifies the management API 65 of the termination of the high-speed update of data, as illustrated in FIG. 7 (S161).

When the management API 65 receives the notification of S161, the management API 65 notifies the pipeline orchestrator 61 of the termination of the high-speed update of data managed by the big-data analysis unit 44 (S162).

When the pipeline orchestrator 61 receives the notification of S162, the pipeline orchestrator 61 instructs the big-data analysis unit 44 to terminate the high-speed update of data (S163).

When the big-data analysis unit 44 receives the instruction of S163, the big-data analysis unit 44 acquires from the pipeline 41 the latest data which has been stored in the pipeline 41 by the normal update path, with respect to the data of the range which has been targeted for high-speed update identified by the metadata, in the data being managed by the big-data analysis unit 44 itself (S164).

Next, the big-data analysis unit 44 overwrites the data of the range which has been targeted for high-speed update identified by the metadata, in the data being managed by the big-data analysis unit 44 itself, with the data acquired in S164 (S165).

Next, the big-data analysis unit 44 deletes, from the metadata corresponding to the range which has been targeted for high-speed update, in the data being managed by the big-data analysis unit 44 itself, the setting that the data of this range is targeted for high-speed update (S166).

Next, the big-data analysis unit 44 terminates updating of data by the high-speed update path (S167).

After the pipeline orchestrator 61 has performed the processing of S163, the pipeline orchestrator 61 gives an instruction to terminate the high-speed update of data to the pipeline which stores the aforementioned data (S168). FIG. 7 illustrates an example in which the pipeline, which is a target of giving the instruction of S168, is the pipeline 41.

When the pipeline 41 receives the instruction of S168, the pipeline 41 terminates updating of data by the high-speed update path (S169).

After the pipeline orchestrator 61 has performed the processing of S163, the pipeline orchestrator 61 gives an instruction, to have the high-speed update of data terminated, to the connector or the agent which acquires the aforementioned data from the information system (S170). The connector or the agent, which is a target of giving the instruction of S170, may be, for example, the POST connector, the POST agent, the GET connector, or a combination of the GET-purpose agent and the GET agent. FIG. 7 illustrates an example in which the connector or the agent, which is a target of giving the instruction of S170, is the POST connector 22. In the following, the POST connector 22 will be described as an example of the connector or the agent. However, the same applies to the POST connector other than the POST connector 22, and the same applies to the POST agent or the GET connector, and also to a combination of the GET-purpose agent and the GET agent.

When the POST connector 22 receives the instruction of S170, the POST connector 22 terminates updating of data by the high-speed update path (S171).

The above describes the operation of the case where the user has specified the termination of high-speed update of data managed by the big-data analysis unit 44 to the application service 51. However, the same applies to the operation of a case where the user has specified the termination of high-speed update of data managed by the big-data analysis unit 44 to an application service other than the application service 51. Also, the same applies to the operation of a case where the user has specified the termination of high-speed update of data managed by the big-data analysis unit 44 to the API platform 52, except that the API platform 52 performs the operation instead of the application service 51.

The above describes the case where the termination of high-speed update of data managed by the big-data analysis unit 44 is specified from the user. However, in a case where the termination time of high-speed update of data is notified in S121, the processing of S163 to S171 is executed also when the time comes to the notified termination time.

As described above, the data association system 30 causes the data collection system and the data storage system 40 which use the normal update path that updates the data at a specific frequency to temporarily use the high-speed update path that updates the data more frequently than does the normal update path (S123, S126 and S128). Therefore, the frequency of update of the data can be changed.

Since the data association system 30 updates the data by using the high-speed update path, it is possible to analyze data of an image forming apparatus, for example, in real time, and create an algorithm based on the analysis. For example, as the data association system 30 learns about information on a change in the amount of consumption of toner in an image forming apparatus through machine learning, the data association system 30 can create an algorithm which predicts the amount of consumption of the toner in the image forming apparatus.

The data association system 30 causes the data collection system and the data storage system 40 to temporarily use the high-speed update path. Therefore, as compared to a configuration in which the data collection system and the data storage system 40 are made to constantly use only the high-speed update path, a load on the information system can be reduced.

The data association system 30 causes the data collection system and the data storage system 40 to use the high-speed update path for only the specific data, which is a part of the data being stored in the data storage system 40. Therefore, as compared to a configuration in which the data collection system and the data storage system 40 are made to use the high-speed update path for all of the data being stored in the data storage system 40, the cost of the data update can be reduced.

In the data association system 30, when the data collection system and the data storage system 40 are using the high-speed update path for the specific data, the data collection system and the data storage system 40 also use the normal update path for this data, and when the data storage system 40 finishes using the high-speed update path (S167), the data storage system 40 causes the specific data to be updated to the latest data which has been acquired by the normal update path (S165). Consequently, for a plurality of items of data stored in the data storage system 40, the times when these items of data were updated can be matched, and consistency between the items of data stored in the data storage system 40 can thereby be improved.

What is claimed is:

1. A data association system comprising:
a data collection system which collects data maintained in an information system;
a data storage system which stores the data collected by the data collection system; and
an update frequency change system which changes a frequency of update of the data stored by the data storage system, wherein
the update frequency change system causes the data collection system and the data storage system which use a normal update path that updates the data at a specific frequency to temporarily use a high-speed update path that updates the data more frequently than does the normal update path.

2. The data association system according to claim 1, wherein the update frequency change system causes the data collection system and the data storage system to use the high-speed update path for only specific data, which is a part of the data being stored in the data storage system.

3. The data association system according to claim 2, wherein when the data collection system and the data storage system use the high-speed update path for the specific data, the normal update path is also used for the specific data, and when the data storage system finishes using the high-speed update path, the data storage system updates the specific data to the latest data which has been acquired by the normal update path.

4. An update frequency change system which changes a frequency of update of data, which is stored by a data storage system that stores data, which is collected by a data collection system that collects data maintained in an information system, the update frequency change system causing the data collection system and the data storage system which use a normal update path that updates the data at a specific frequency to temporarily use a high-speed update path that updates the data more frequently than does the normal update path.
